(19) United States
(12) Patent Application Publication
(10) Pub. No.: US 2013/0311912 A1
(43) Pub. Date: Nov. 21, 2013

(54) GUI GENERATOR, INTEGRATED CIRCUIT, GUI GENERATING METHOD, AND GUI GENERATING PROGRAM

(71) Applicants: Mitsuhiro Aso, Osaka (JP); Hidehiko Shin, Osaka (JP)

(72) Inventors: Mitsuhiro Aso, Osaka (JP); Hidehiko Shin, Osaka (JP)

(21) Appl. No.: 13/982,277

(22) PCT Filed: Jul. 12, 2012
(86) PCT No.: PCT/JP2012/004506

§ 371 Date: Jul. 29, 2013

(30) Foreign Application Priority Data
Jul. 28, 2011 (JP) 2011-166062

(51) Int. Cl. G06F 3/0481

(52) U.S. Cl. CPC G06F 3/0481
USPC 715/762

(57) ABSTRACT

An information terminal includes: a device information management unit that obtains device information identifying a first device and a second device which are connected to a network; a device coordination service information management unit that obtains coordination information which identifies a coordination behavior achieved with a first function of the first device and a second function of the second device; and a GUI generating and drawing unit which draws first and second GUI components and a third GUI component in association with each other, the first and the second GUI components indicating the first and the second devices identified by the device information, and the third GUI component indicating the coordination behavior identified by the coordination information.

### TECHNICAL FIELD

The present invention relates to a graphical user interface (GUI) generator including: a device information obtainment unit which obtains device information that identifies a device; and a GUI drawing unit which draws a GUI component.

### BACKGROUND ART

Conventionally, there are graphical user interface (GUI) generators, such as tablet terminals or smartphones, including: device information obtainment units which obtain device information that identify devices; and GUI drawing units which draw GUI components (see patent literature (PTL) 1).

### CITATION LIST

### Patent Literature

### [PTL 1]

Japanese Unexamined Patent Application Publication No. 2008-305103

### SUMMARY OF INVENTION

### Technical Problem

However, with no provision of a drawing that is required to allow easy usage of a coordination behavior performed by a first device and a second device, it is expected that the coordination behavior is not easily usable.

The present invention has an object of providing an information terminal which makes it possible to use the coordination behavior more easily.

### Solution to Problem

In order to achieve the above object, a graphical user interface (GUI) generator according to an aspect of the present invention is a GUI generator including: a device information obtainment unit configured to obtain device information identifying a first device and a second device which are connected to a network; a coordination information obtainment unit configured to obtain coordination information which identifies a coordination behavior achieved with a first function of the first device and a second function of the second device; and a GUI drawing unit configured to draw first and second GUI components and a third GUI component in association with each other, the first and the second GUI components indicating the first and the second devices identified by the device information, and the third GUI component indicating the coordination behavior identified by the coordination information.

Note that these general and specific aspects may be implemented using a system, a method, an integrated circuit, a computer program, or a recording medium, or any combination of systems, methods, integrated circuits, computer programs, or recording media.

### ADVANTAGEOUS EFFECTS OF INVENTION

An information terminal which can make it easier to use the coordination behavior can be provided.

### BRIEF DESCRIPTION OF DRAWINGS

FIG. 1 is a configuration diagram of an information terminal including a device coordination service display apparatus according to an embodiment of the present invention.

FIG. 2 is a diagram showing an example of a device information table according to the embodiment of the present invention.

FIG. 3A is a diagram showing an example of the device coordination service information table according to the embodiment of the present invention.

FIG. 3B is a diagram showing an example of an executable-behavior definition file of a photo viewing service.

FIG. 3C shows an example of an executable-behavior definition file of a power management service.

FIG. 4 is a diagram showing, according to the embodiment of the present invention, an example of a GUI representing a relationship between a device coordination service and devices which execute the device coordination service.

FIG. 5 is a flowchart showing an example of GUI drawing processes performed by the device coordination service display apparatus according the embodiment of the present invention.

FIG. 6 is a flowchart showing an example of processes performed by the GUI control unit when the GUI according to the embodiment of the present invention is operated by a user.

FIG. 7A is a diagram showing an example of a GUI which shows a relationship between a service and devices according to the embodiment of the present invention.

FIG. 7B is a diagram showing an example of a GUI indicating a relationship between a service and devices according to the embodiment of the present invention.

FIG. 8A is a diagram showing another example of a GUI indicating a relationship between a service and devices according to the embodiment of the present invention.

FIG. 8B is a diagram showing an example of another GUI indicating a relationship between a service and devices according to the embodiment of the present invention.

FIG. 9A is a diagram showing a GUI.

FIG. 9B is a diagram showing a GUI.

FIG. 10 is a diagram showing a history information storage unit and others.

FIG. 11 is a diagram showing a GUI.

FIG. 12 is a diagram showing a user information storage unit and others.

FIG. 13A is a diagram showing a GUI.

FIG. 13B is a diagram showing a GUI.

FIG. 13C is a diagram showing a GUI.

FIG. 14 is a diagram showing a first and a second rooms.

FIG. 15 is a diagram showing this system.

FIG. 16 is a diagram showing a GUI.

FIG. 17 is a diagram showing a GUI.

FIG. 18 is a diagram showing an information terminal.

### DESCRIPTION OF EMBODIMENTS

### Underlying Knowledge Forming Basis of the Present Invention

The technique described here presents a user various device coordination services, which are achieved by combining functions of various devices connected to a network, in an easily comprehensible manner. Thus, a graphical user interface (GUI) technique is provided with which it is easy for a user to select and execute a function of a device.

During research and development of an information terminal, such as a tablet terminal, the inventors noticed that the following problem can occur.

Specifically, recent years have seen that audio visual (AV) devices, such as a television (TV) and a recording device, mobile information terminals, such as a tablet and a smartphone, and various digital devices, such as a personal computer and a printer, are interconnected via a network. Furthermore, a device coordination service realized by using the functions of various devices in coordination with each other is presented.

For example, according to a digital living network alliance (DLNA) standard which specifies a method for interconnecting devices, video content stored in a recording device is selected through a mobile information terminal connected via a network. Then, for example, the selected video content can be played on a TV connected via a network.

However, in such a device coordination service, a plurality of devices operates in coordination. Thus, relationship between such devices becomes complicated or the number of functions offered by the device coordination service increases. Thus, there are cases where usable functions are not clear to the users.

Thus, realization of a new GUI, which presents a user the device coordination service in an easily comprehensible manner and allows the user to use the device coordination service easily, is desired.

To realize this, according to a conventional technique, the GUI includes: a content display area for displaying information of content held in a device; an operation display area for displaying information about an operation to be executed on the content: and a device display area for displaying information about a target on which the operation is to be executed. Then, information displayed in each of the display areas is selected through an operation unit of a device control terminal. When the selection is made, a service offered by a device connected via a wide area network is displayed, as a candidate of a target, in a device display area. A conventional technique includes the above features (e.g., see PTL 1).

However, the above-described conventional technique presents a user, in an easily comprehensible manner, a device coordination service for operating content held in a device, only in the case where three devices are coordinated. Thus, the conventional technology can hardly handle the device coordination service in a case where, in addition to the operation of content, (i) a function of a certain device is used through another device or (ii) four or more devices behave in coordination.

For example, in addition to AV devices, connection of white goods, such as an air conditioner and a refrigerator, to a network is newly expected in the future. This can further complicate the coordination between the devices and increase the types of the device coordination service. However, the GUI according to the conventional technique cannot present user the device coordination service, which is expected to increase in the future, in an easily comprehensible manner to allow easy usage.

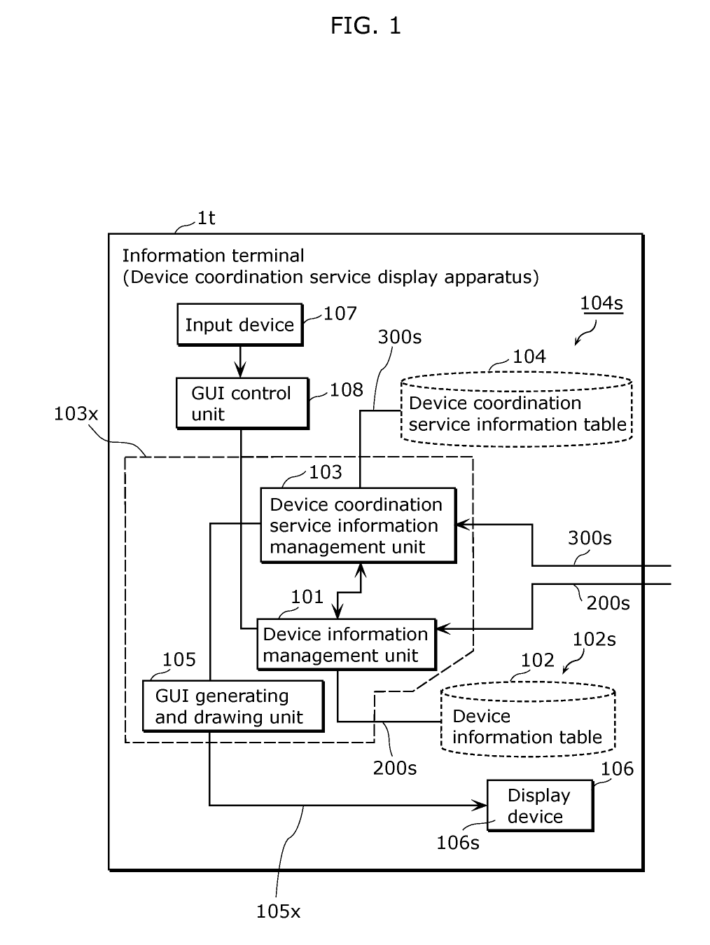

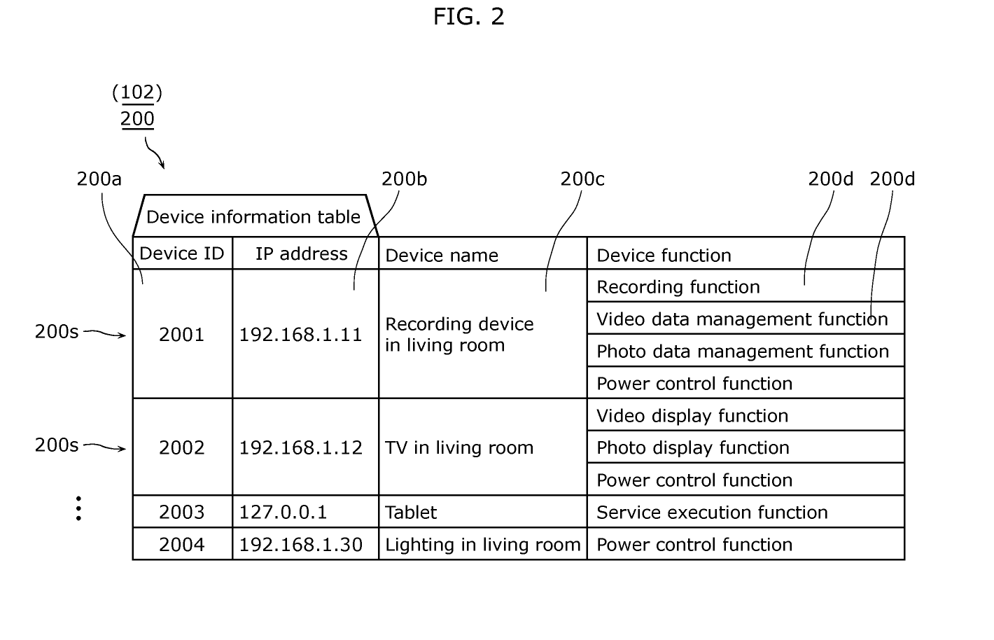

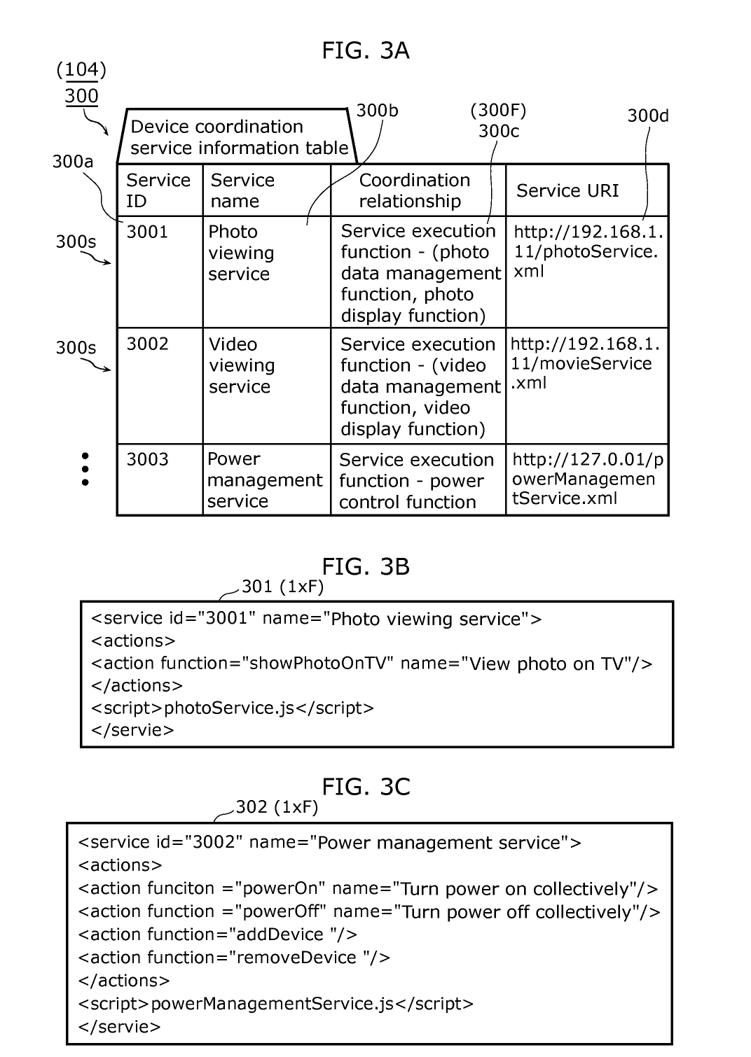

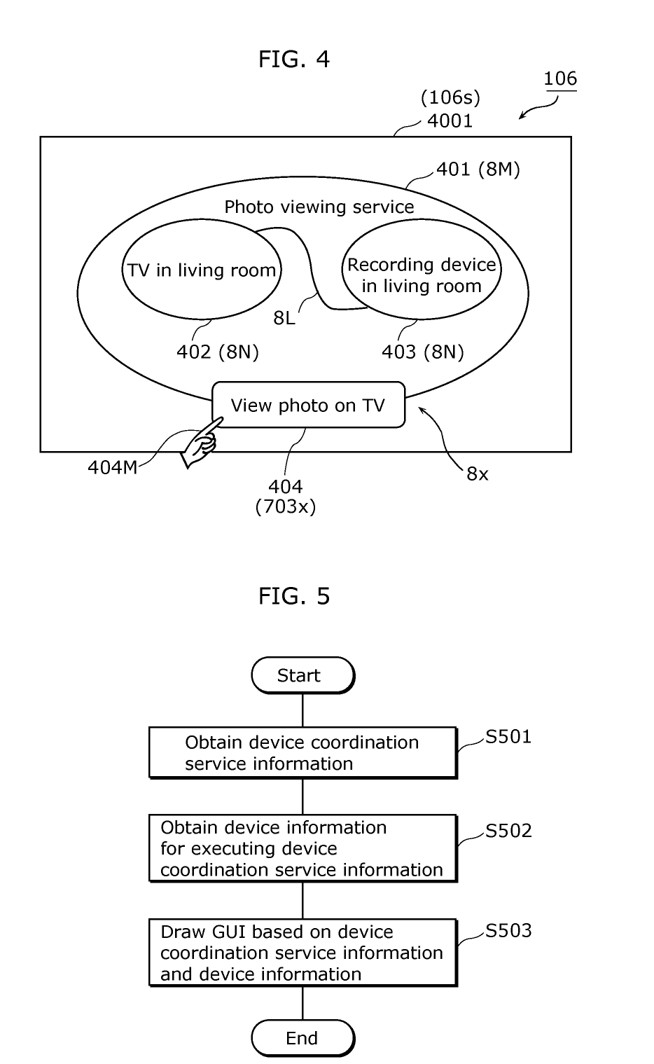

In order to solve such a problem, a graphical user interface (GUI) generator (see an information terminal 1t in FIG. 1 described later) according to an aspect of the present invention is a GUI generator which includes: a device information obtainment unit (a device information management unit 101) configured to obtain device information (a device information table 200 in FIG. 2) identifying a first device and a second device which are connected to a network; a coordination information obtainment unit (a device coordination service information management unit 103) configured to obtain coordination information (a device coordination service information table 300 in FIG. 3A) which identifies a coordination behavior achieved with a first function of the first device and a second function of the second device; and a GUI drawing unit (a GUI generating and drawing unit 105) configured to draw first and second GUI components (node-type GUI components 402 and 403 in FIG. 4) and a third GUI component (a group node-type GUI component 401) in association with each other, the first and the second GUI components indicating the first and the second devices identified by the device information, and the third GUI component indicating the coordination behavior identified by the coordination information.

Thus, the drawn and displayed GUI components include the first to the third GUI components which are associated with each other. With this, a graphical representation that is required to easily use the coordination behavior is provided, making it easy to use the coordination behavior.

Note that, for example, the coordination information (the device coordination service information table 300) identifies the first and the second functions for achieving the coordination behavior, and the first device is a device (e.g., a recording device in FIG. 2) indicated by the device information as having the identified first function, and the second device is a device (a TV) indicated by the device information as having the identified second function.

With this, even when there are one of two devices that includes a first function and a second function and the other of the two devices that includes the first function and the second function, an appropriate behavior is performed. In other words, for both of the two devices, a first GUI component of the first device and a second GUI component of the second device among the two devices, and the third GUI component associated with the first and the second GUI components are drawn. With this, suitable drawing is performed for both of the two devices, ensuring suitable representation.

For example, the GUI generator may further include: a display device (a display device 106) which displays a GUI (see GUI 4001) including the first to the third GUI components drawn by the GUI drawing unit; an input device (an input device 107) which receives an operation performed by a user on a GUI component included in the GUI; and a GUI control unit (a GUI control unit 108) configured to execute a GUI behavior associated with the GUI component selected by the user with the operation received by the input device.

With this, when an operation is performed, the GUI behavior for causing the above-described coordination behavior to be performed is executed, and coordination behavior is performed. With this, the operation required to cause the performance of the coordination behavior becomes simply an operation in the GUI generator, allowing a required operation to be simple.

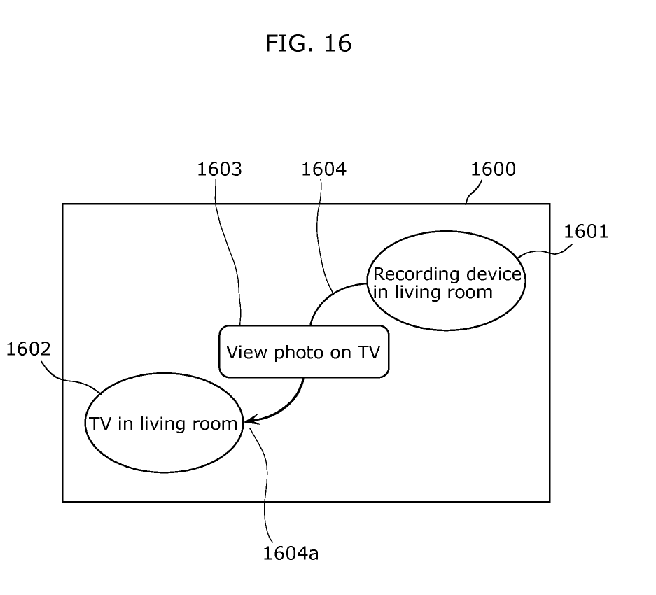

For example, the GUI drawing unit may be configured to draw a line which connects the first GUI component and the second GUI component, the line being a straight line or a curved line (see a line 8L in FIG. 4 and a line 16043 in FIG. 16).

With this, the above-described line is drawn and displayed indicating the association, which makes the association relatively easy to comprehend.

For example, the GUI drawing unit may be configured to (i) draw information representing the GUI component on which the operation received by the input device is performed, and, (ii) after the receipt, draw the information in a manner different from a manner in which the information is drawn before the receipt.

For example, the GUI drawing unit may be configured to (i) draw the first and the second GUI components indicating the first and the second devices and (ii) draw, as the third GUI component indicating the coordination behavior, a group node-type GUI component indicating a group which includes the first and the second GUI components.

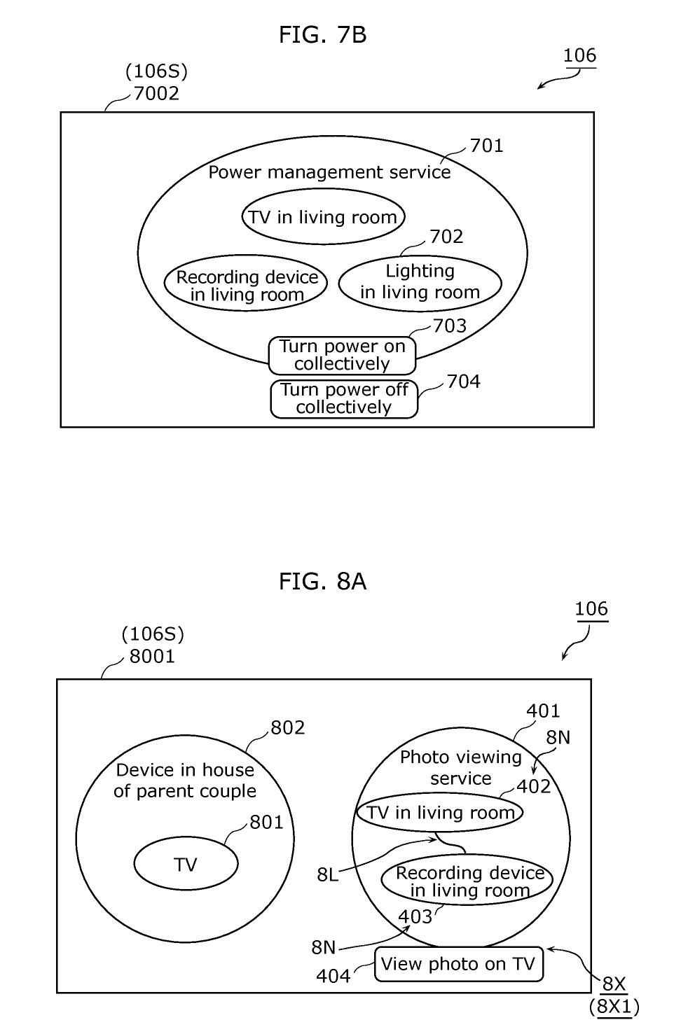

For example, in a case where the input device receives a drag-and-drop operation (an operation 702m) of a fourth GUI component (a node-type GUI component 702) indicating one device to the drawn third GUI component (a group node-type GUI component 701 in FIG. 7A) performed by a user, the GUI control unit may be configured to register the one device (a lighting in a living room) indicated by the fourth GUI component, as one of devices that operate when the coordination behavior (a power management service) is executed which is indicated by the third component on which the drag-and-drop operation is performed.

With this, registration is easy.

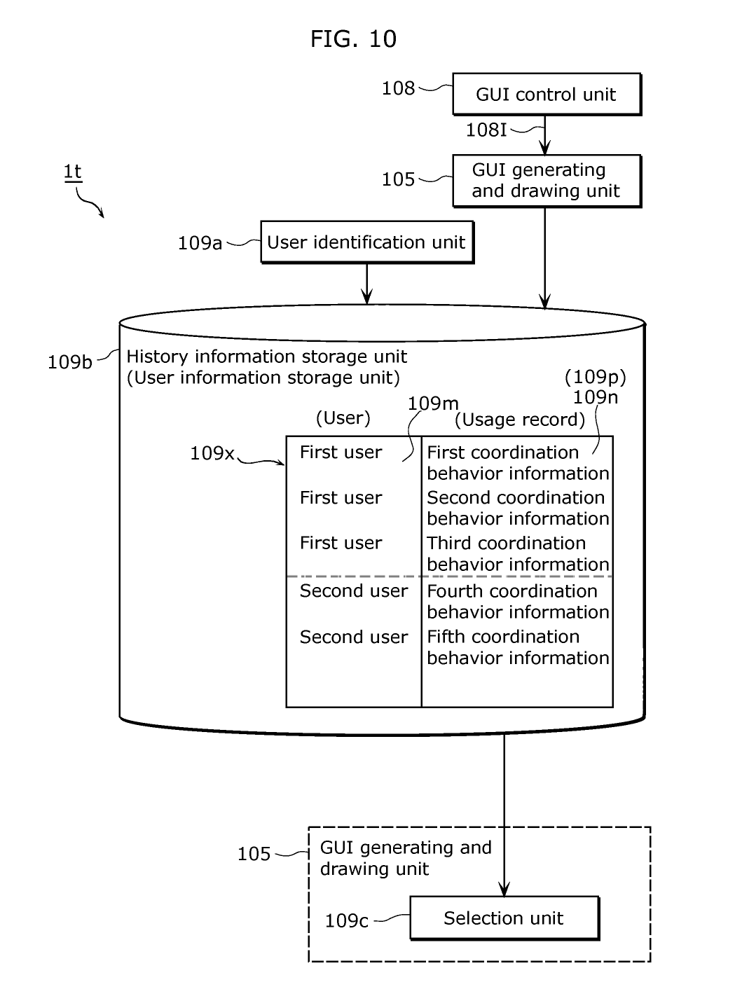

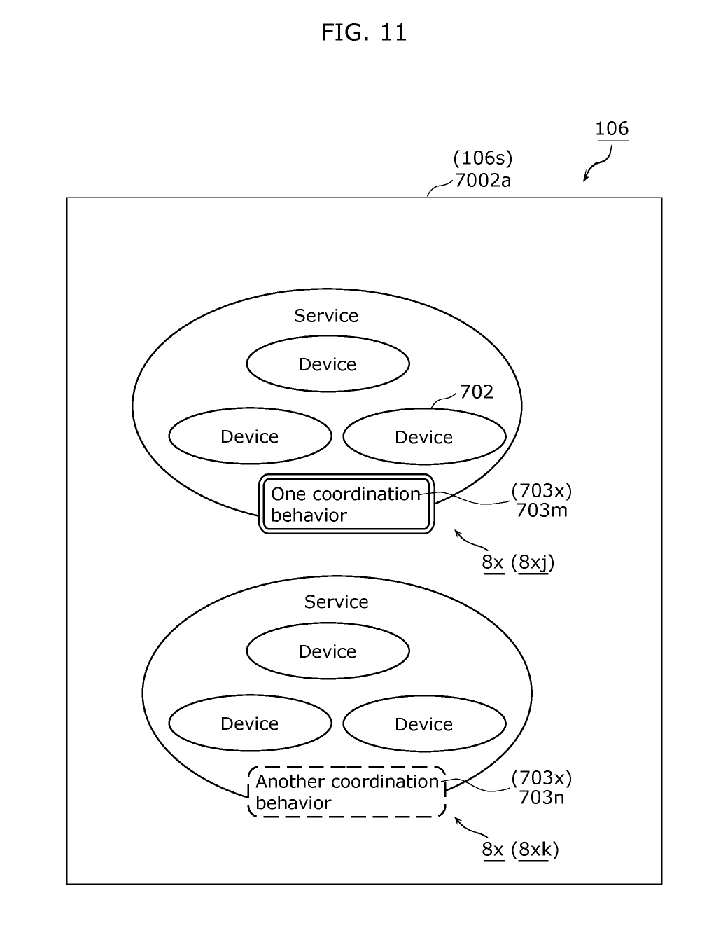

For example, it may be that the GUI generator further includes a history storage unit (a history information storage unit 109b) configured to store data (data 109x in FIG. 10) which identifies a total number of executions of the coordination behavior, wherein the GUI drawing unit is configured to (i) perform a drawing in a form (see a button-type GUI component 703m in FIG. 11) suitable for a case in which a total number of operations is relatively large, when the total number of executions identified by the stored data is larger than a threshold value, and (ii) perform a drawing in a form (see a button-type GUI component 703n) suitable for a case in which the total number of operations is relatively small, when the total number of executions identified by the stored data is smaller than the threshold value.

With this, drawing is performed in a suitable form in any of the cases, making it possible to ensure representation in a suitable form.

Note that, the above-described threshold value may be, for example, a relatively appropriate value that is determined through an experiment.

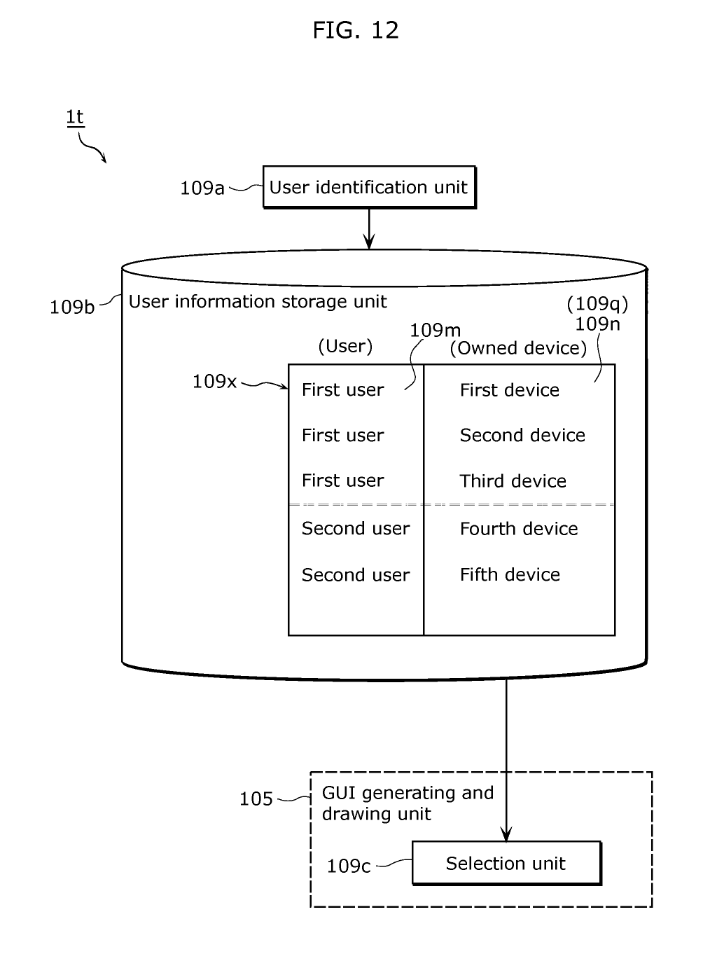

For example, it may be that the GUI generator further includes a storage unit (a user information storage unit 109b) configured to store data (data 109x in FIG. 12) which identifies a device owned by a user of the GUI generator, wherein the GUI drawing unit is configured to (i) perform a drawing in a form suitable for a case in which a total number of operations is relatively large, in a case where a function of the owned device identified by the data is used when the coordination behavior is executed, and (ii) perform a drawing in a form suitable for a case in which the total number of operations is relatively small, in a case where the function of the owned device identified by the data is not used when the coordination behavior is executed.

With this, in any cases, drawing is performed in a suitable form, making it possible to ensure representation in a suitable form.

For example, it may be that the storage unit is configured to store a plurality of pieces of the data (information 109n), each of the pieces of the data identifies a device owned by, among a plurality of the users, the user corresponding to the piece of the data, the GUI generator further includes an identification unit (a user identification unit 109a) configured to identify, among the users, a user to which the GUI is presented, and the GUI drawing unit is configured to switch forms of a drawing between (i) a form suitable for the case in which the total number of operations is relatively large and (ii) a form suitable for the case in which the total number of operations is relatively small, according to the data of the identified user.

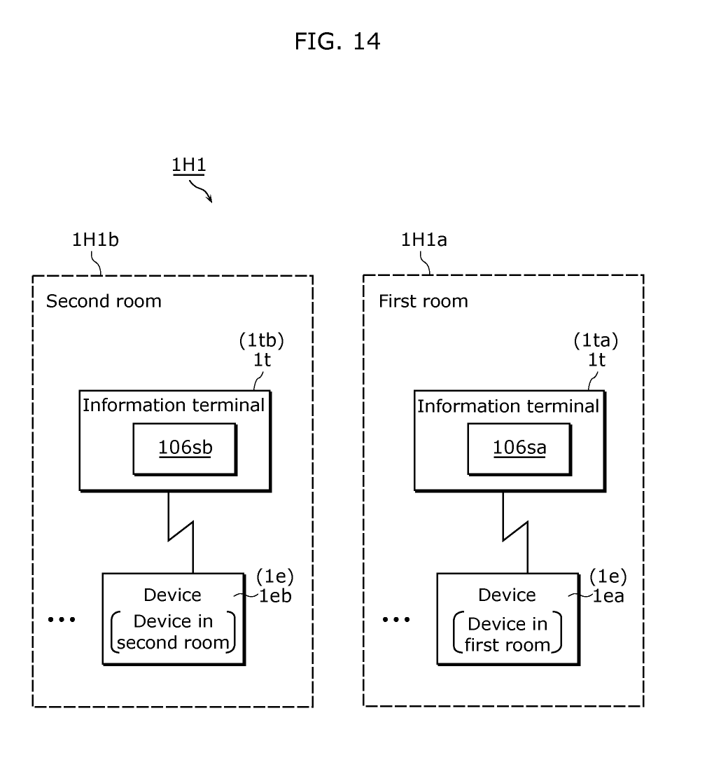

For example, it may be that the device information obtainment unit is configured to communicate wirelessly with two or more devices including the first and the second devices positioned in a neighboring area (a first room 1H1a in FIG. 14) of the GUI generator, the device information identifies the two or more devices positioned in the neighboring area, and avoids identifying a device positioned in an area (a second room 1H1b) different from the neighboring area, and the GUI drawing unit is configured to (i) draw only two or more GUI components indicating the two or more devices positioned in the neighboring area, and (ii) avoid drawing a GUI component of the device positioned in the area different from the neighboring area.

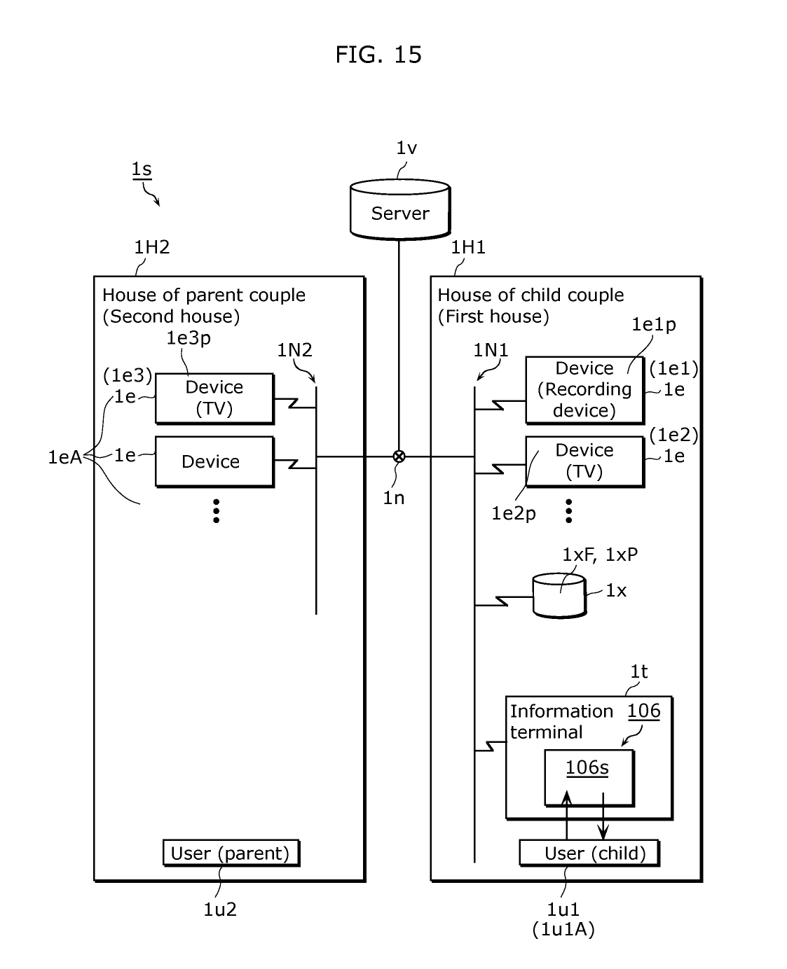

For example, it may be that a system (a system 1s) including the GUI generator includes the first and the second devices, and a third device, the first and the second devices are provided in a first house (a first house 1H1 in FIG. 15), the third device is provided in a second house (a second house 1H2), the coordination behavior is achieved with (i) the first and the second functions of the first and the second devices in the first house and (ii) a third function of the third device in the second house, the third function being a function same as the second function, the GUI drawing unit is further configured to draw a GUI component indicating the third device, and the GUI control unit is configured to cause, as the GUI behavior that is executed when the operation is received, (i) the first and the second devices to behave with the first and the second functions, respectively, and (ii) the third device to behave with the third function.

Note that, for example, the first and the second devices in the first house may be connected to a first network in the first house, and the third device in the second house may be connected to a second network different form the first network.

Furthermore, it may be that the first and the second devices in the first house are not in a remote location that is remote from the GUI generator, and the third device in the second house is in the remote location.

For example, in a case where the GUI generator includes the second function, the GUI generator may perform, as the second device, a behavior with the second function when the coordination behavior is executed.

For example, the third GUI component (e.g., see a group node-type GUI component 401 in FIG. 4) may be associated with the line (the line 8L) which connects the first GUI component (a node-type GUI component 402) and the second GUI component (the node-type GUI component 402).

For example, the third GUI component (e.g., a GUI component 1603) may be drawn on the line (a line 1604).

The line (the line 1604) may be an arrow (the line 1604) indicating a direction of flow of data between the first device indicated by the first GUI component (the GUI component 1601) and the second device indicated by the second GUI component (the GUI component 1602) when the coordination behavior is executed.

With this, the direction of a flow of data in the coordination behavior is indicated, providing a representation with which the coordination behavior is relatively easily comprehensible.

The third GUI component may be drawn between the first GUI component (the GUI component 1601) and the second GUI component (the GUI component 1602).

Thus, the technique described here solves the conventional problem. In other words, according to the technique described here, in the device coordination service which is achieved through coordination of a number of devices, it is possible to provide a new GUI that can present a user the relationship between the device coordination service and the devices in an easily comprehensible manner and allow the user to easily use the device coordination service.

Note that, in order to solve the conventional problem, as a graphical user interface (GUI) generator according to an aspect of this technique, a GUI generator including the following is also conceivable: a device information obtainment unit which obtains device information on a device connected to a network; a coordination information obtainment unit that obtains coordination information which identifies a function for achieving a behavior among a plurality of the behaviors performed when a coordination behavior for achieving a coordination service is performed; and a GUI generating and drawing unit which draws, as a GUI, a relationship between (i) the two or more devices including the device which is indicated by the obtained device information on the device as having the identified function and (ii) the coordination service, the GUI including (i) the node-type GUI component which indicates the coordination service and (ii) the connected two or more node-type GUI components which indicate the devices and including the node-type GUI components each of which indicates one of the two or more devices.

In other words, the drawn GUI includes: the node-type GUI component which indicates the coordination service; and the two or more node-type GUI components (GUI components) which indicate devices. In addition, for example, in the case of the connected two or more node-type GUI components which indicate the devices, when the number of the included node-type GUI components is two, the two node-type GUI components are connected. When there are n node-type GUI components where n≧3, at least one of the connected n−1 node-type GUI components is connected to the remaining node-type GUI component.

With this configuration, the relationship between (i) a plurality of the devices that execute a device coordination service and (ii) the device coordination service is represented, using GUI, as a relationship diagram of the node-type GUI components. Thus, a user who uses the device coordination service can confirm the relationship between the device coordination service and the related devices in a GUI representation that is easily comprehensible. In addition, through the operation of the node-type GUI component, the device coordination service can be easily executed.

With the device coordination service display apparatus according to the technique described here, a user can visually confirm, as the diagram indicating the relationship among the node-type GUI components, a relationship between the devices that execute the device coordination service and the device coordination service. The node-type GUI component is operated after the above-described confirmation, which makes it possible to execute the device coordination service easily.

These general and specific aspects may be implemented using a system, a method, an integrated circuit, a computer program, or a recording medium, or any combination of systems, methods, integrated circuits, computer programs, or recording media.

The following describes in detail an embodiment of the present invention with reference to drawings.

The exemplary embodiment described below shows a general or specific example of the present invention. The numerical values, shapes, materials, structural elements, the arrangement and connection of the structural elements, steps, the processing order of the steps etc. shown in the following exemplary embodiment is mere examples, and are not intended to limit the present invention. Furthermore, among the structural elements in the following exemplary embodiment, structural elements not recited in any one of the independent claims indicating the broadest concept are described as arbitrary structural elements.

The GUI generator (information terminal 1t) includes: a device information management unit 101 which obtains device information 200s (FIG. 1) on a device 1e connected to a network (e.g., a network 1n in FIG. 15); a device coordination service information management unit 103 that obtains coordination information 300s (FIG. 3A and FIG. 1) identifying each of functions (e.g., a photo data management function and a photo display function in a second row in FIG. 3A) for achieving a behavior among behaviors (e.g., behaviors 1e1p and 1e2p in FIG. 15) which are performed to execute the coordination behavior for achieving the coordination service; and a GUI generating and drawing unit 105 which draws, as a graphical user interface (GUI) (GUI 8x, GUI (screen) 106s), a relationship (a relationship of GUI 8x in FIG. 4) between (i) two or more devices (the device 1e1 and the device 1e2) including devices (a device (a recording device) 1e1 and a device (a TV) 1e2 in FIG. 15) indicated by the obtained device information 200s of the devices as having the identified above-described functions (function 300F) and (ii) a coordination service (a photo viewing service), the GUI (GUI 8x, GUI (screen) 106s) including (i) the node-type GUI component (a group node-type GUI component 8M in FIG. 4) which indicates the coordination service and (ii) two or more node-type GUI components which are connected by a line 8L and includes the node-type GUI components (node-type GUI components 8N) each of which indicates one of the above-described two or more devices (device 1e1 and 1e2).

In other words, when the connected two or more node-type GUI components 8N which indicate devices include two node-type GUI components, the two node-type GUI components are connected. In addition, when there are n node-type GUI components, where n≧3, at least one of the connected n−1 node-type GUI components is connected to the remaining node-type GUI component.

Note that, for example, a system 1s (FIG. 15) including the information terminal 1t may include a first, a second and a third devices (devices 1e1, 1e2, and 1e3 in FIG. 15) each of which is the device 1e.

The first device 1e1, which is for example a recording device, and the second device 1e2, which is for example a TV, may be provided in the first house 1H1 (FIG. 15).

The following may apply to the third device 1e3, which is for example a TV.

Specifically, the third device 1e3 may be provided in the second house 1H2.

In addition, when the first device 1e1 and the second device let positioned in the first house 1H1 perform the first behavior 1e1p and the second behavior 1e2p respectively, the third device 1e3 may perform the third behavior 1e3p (e.g., displaying of the same image as the image displayed on the second device 1e2) that is the behavior same as the second behavior 1e2p (e.g., displaying of an image which is output by the first device 1e1) may be performed, and thus a coordination behavior by the first to the third devices 1e1 to 1e3 may be achieved.

A node-type GUI component 8N (FIG. 4) indicating the third device 1e3 may be drawn by the GUI generating and drawing unit 105 and displayed on the display device 106.

In addition, as the GUI behavior executed when an operation 404M (FIG. 4), such as a touch operation performed by a user, is received, the GUI control unit 108 may cause the first and the second devices 1e1 and 1e2, to respectively perform the first and the second behavior 1e1p and 1e2p, and cause the third device 1e3 to perform the third behavior 1e3p described earlier.

With this, in the second house 1H2 as well, which is a house of a parent couple or the like, the same image is displayed and an appropriate behavior is performed in both houses (the first and the second houses 1H1 and 1H2). With this, an appropriate behavior can be performed more reliably.

Furthermore, an operation or the like by the parent couple in the second house 1H2 is not necessary. It is simply necessary to perform in the first house 1H1, which is a house of the child couple or the like, the above-described processing through the information terminal 1t. With this, it is possible to avoid the case in which an operation hard to perform is required, requiring only a simple operation.

### Embodiment

FIG. 1 is a configuration diagram of a device coordination service display apparatus (information terminal) according to an embodiment of the present invention.

In FIG. 1, a device information management unit 101 manages device information (data 200s) defined (stored) in a device information table 102, and a device coordination service information management unit 103 manages a device coordination service information (data 300s) defined in a device coordination service information table 104.

FIG. 2 is a diagram showing a device information table 200 as an example of the device information table 102.

In the device information table 200, as the device information, a device identifier (ID), a device internet protocol (IP) address, a device name, and a device function (a second column to a fifth column of the table in FIG. 2) are defined.

In other words, for example, by the device information table 200, two or more pieces of the data 200s (the data 200s in the second row to the fifth row, the data 200s in the sixth row to the eighth row, . . . in the table in FIG. 2) may be stored.

Furthermore, each pieces of the data 200s may include one or more among a device ID (first data) 200a, an IP address (second data) 200b, a device name (third data) 200c, and a device function (fourth data 200d) of the device (e.g., see a device 1e in FIG. 15 described later) corresponding to the data 200s.

Note that, the number of the pieces of the fourth data 200d may be, for example, two or more, as shown by the data 200s of the second row to the fifth row and the data 200s of the sixth row to the eighth row in FIG. 2.

Among the device ID or the like included in each data piece 200s, the device ID is an identifier for uniquely identifying a device (see the device 1e in FIG. 15) connected to a network.

Note that, a part or the entirety of the above-described network is, for example, a network connected via a wireless communication link, such as a wireless local area network (LAN), Bluetooth, or a near field communication (NFC).

Note that, as the device ID (first column of the table in FIG. 2), for example, a media access control (MAC) address of the device having the device ID, a universal unique identifier (UUID) that is an identifier specified in the universal plug and play (UPnP) standard, which is a network interconnection standard, of the device may be used.

Furthermore, the device name (third column) is a name of the device (the device 1e).

Note that, for example, the device name of the device indicated by the device ID “2001” in the second to the fifth rows in FIG. 2 is a “recording device in living room”.

Furthermore, a device function (fourth column) is data which identifies the function of the device of the device information (the data 200s) including the device function that can be used via the network.

For example, as functions of the recording device (recording device in living room) indicated by the device ID “2001” in the second row to the fifth row in FIG. 2, a “recording function” (second row), a “video data management function” (third row), a “photo data management function” (fourth row), and a “power control function” (fifth row) are defined.

Note that, the information terminal (device coordination service display apparatus) it is, for example, a “tablet” that is a device corresponding to the data 200s in the ninth row.

FIG. 3A is a diagram showing, as an example of the device coordination service information table 104, a device coordination service information table 300.

In the device coordination service information table 300, as device coordination service information (the data 300s), a service ID, a service name, a coordination relationship, a service uniform resource identifier (URI) are defined (first column to fourth column).

Specifically, the device coordination service information table 300 may store one or more pieces of the data 300s (the second row, the third row . . . in FIG. 3A).

Each of the pieces of data 300s may include a service ID (first data) 300a, a service name (second data) 300b, a coordination relationship (third data) 300c, and a service URI (fourth data) 300d of a service (a coordination service, a coordination behavior) corresponding to the data 300s.

The service ID (for example, “3001” in the second row) in the device coordination service information table 300 is an identifier for managing the data 300s (a device coordination service (a photo viewing service) corresponding to the data 300s) including the service ID.

The service name (second column) is a name which describes the device coordination service in an easily comprehensible manner.

Furthermore, a coordination relationship (third column) shows, for example, a connection relationship between functions of two or more devices which are required to execute the device coordination service corresponding to the data 300s including the coordination relationship.

For example, the coordination relationship of a “photo viewing service”, which is defined by a service ID “3001” (second row), is indicated as a “service execution function—(photo data management function, photo display function)” (“photo display function—photo data management function”).

Here, the symbol “-” means that the devices on either side of the symbol “-”, having their respective functions, are interconnected.

Furthermore, there is a format of a “service execution function—(photo data management function, photo display function)” which is described using symbols “( )”, that is, a format of “function A—(function B, function C)”. This format indicates that the device having a function A is connected to each of a device or the like having a function of B and a device or the like having a function of C.

Note that, although the coordination relationship is described as a connection relationship of functions of devices, the data of connection relationship can also be understood as indicating, in addition to the indication of the connection relationship of functions of devices, a connection relationship between two or more functions of devices and a device coordination service using those functions.

For example, the data of the coordination relationship can also be indicated as a “service execution function—(photo data management service, photo display function)” (second row). Note that, the above-described “photo data management service” is shown as a “photo data management function” in FIG. 3. In this case, the service execution function is a function in a device coordination service that is executed with a coordinated behavior by a plurality of the devices, and is connected to, for example, a “photo data management service” that has a function of managing photo data.

Next, the service URI (fourth column) in the device coordination service information table 300 indicates a location of an executable-behavior definition file, which describes a specific behavior to be executed by the device coordination service (e.g., the “photo viewing service”) corresponding to the data 300s in which the service URI (http://192.168.1.11/photoService) is defined.

Here, the executable-behavior definition file is described in a form that can be interpreted by a device (e.g., the table that has a device ID “2003” (ninth row) in FIG. 2) including a service execution function among the device functions shown in FIG. 2.

For example, the executable-behavior definition file is described in a markup language, such as an extensible markup language (XML), a hypertext markup language (HTML), or a program language, such as a Java (Java is a registered trademark) script.

Furthermore, the location of a file is described in a uniform resource identifier (URI) format.

Note that, the executable-behavior definition file may be, for example, a file 1xF stored in a server 1x of 9 shown in FIG. 15.

FIG. 3B and FIG. 3C show, as examples, an executable-behavior definition file 301 (file 1xF) for a photo viewing service and an executable-behavior definition file 302 (file 1xF) for a power management service 302, respectively.

In executable-behavior definition files 301 and 302, a service ID and a service name are defined in a service tag. Then, in an action tag, a function name (a function attribute) specifying a behavior to be executed and a function name (a name attribute) are defined. In addition, in a script tag, a file name or the like of the program in which a function corresponding to the function name is implemented is defined.

The above has described, with reference to FIG. 2 and FIG. 3A to FIG. 3C, the details of the device information table 102 and the device coordination service information table 104. Next, a description of a configuration shown in FIG. 1 is resumed.

In FIG. 1, the GUI generating and drawing unit 105 obtains device coordination service information (the data 300s) from the device coordination service information management unit 103.

Then, the GUI generating and drawing unit 105 performs the following processes for each pieces of the obtained device coordination service information (the data 300s). In other words, there are two or more pieces of device information (the data 200s) which are required to execute the device coordination service of the device coordination service information which is identified based on a coordination relationship definition (third data 300c in FIG. 3A) of the device coordination service information. In the process, the two or more pieces of the device information are obtained from the device information management unit 101.

Subsequently, the GUI generating and drawing unit 105 draws, as the node-type GUI component (see the node-type GUI component 8N and a group node-type GUI component 8M in FIG. 4 described later), the obtained device coordination service information (the data 300s) and device information (the data 200s).

Then, more specifically, the GUI generating and drawing unit 105 draws a relationship between the device coordination service of the device coordination service information and the two or more devices which execute the device coordination service, by connecting a plurality of the node-type GUI components with a straight line and a curved line (see a line 8L or the like in FIG. 4).

FIG. 4 is a diagram showing an example of a GUI (GUI 4001) drawn by the GUI generating and drawing unit 105 based on the device coordination service information (the data 300s in the second row) indicated by the service ID “3001” in FIG. 3A.

In FIG. 4, a node-type GUI component 402 indicating a TV in a living room (sixth row to eighth row in FIG. 2) and a node-type GUI component 403 indicating a recording device in a living room (second row to fifth row in FIG. 2) which are device names of the devices that execute the photo viewing service (second row in FIG. 3A) are drawn and are connected by a curved line (the line 8L). The connection relationship between the two devices is thus expressed.

Furthermore, the node indicating the photo viewing service (a group node-type GUI component 401) groups the node-type GUI component 402 and the node-type GUI component 403 into one group. In other words, the group node-type GUI component 401 represents a group including other two components that are the node-type GUI component 402 and the node-type GUI component 403.

Note that, such a node-type GUI component which groups the node-type GUI components is hereinafter referred to as a group node-type GUI component.

Furthermore, the group node-type GUI component 401 includes a drawing of a button-type GUI component 404 which enables the function provided by the photo viewing service to be executed.

Here, a character string “view photo on TV” drawn on the button-type GUI component 404 is obtained from a name attribute in an action tag of the executable-behavior definition file 301 in FIG. 3B and set.

Furthermore, the function executed when the user (see a user 1u1A in FIG. 15) selects the button-type GUI component 404 is a function defined by the function name obtained from the function attribute in the action tag of the executable-behavior definition file 301 in FIG. 3B.

As described above, the GUI generating and drawing unit 105 can draw, as the node-type GUI component (see the group node-type GUI component 401 or the like), the relationship between the device coordination service and one or more devices that execute the device coordination service, and draw a button-type GUI component (the button-type GUI component 404) which allows a user to select and execute a function offered by the device coordination service.

Subsequently, in FIG. 1, a display device 106 displays the GUI (an image of the GUI) drawn by the GUI generating and drawing unit 105 on a screen, such as a liquid crystal display, or a touch panel display.

An input device 107 is an input device, such as a mouse, a touch panel, or a keyboard, and notifies the GUI control unit 108 of a user operation (e.g., an operation 404M in FIG. 4) for operating the GUI drawn by the GUI generating and drawing unit 105.

The GUI control unit 108 is notified, from the input device 107, of the user operation performed on the GUI drawn by the GUI generating and drawing unit 105. When receiving the notification, the GUI control unit 108 identifies the GUI component (the node-type GUI component or the button-type GUI component) on which the notified operation has been performed, and executes the function assigned to the identified GUI component.

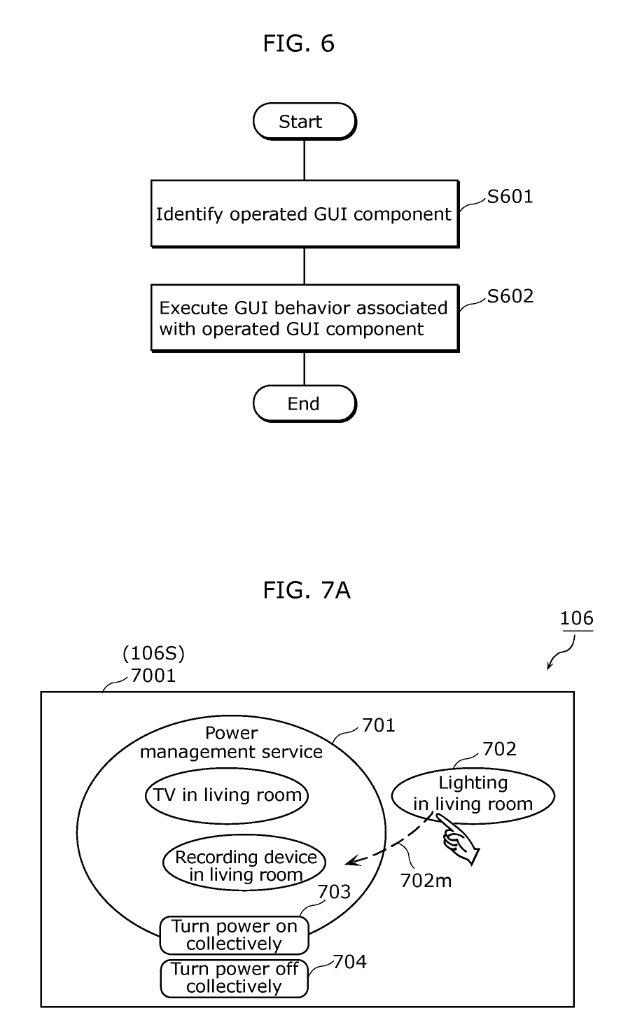

The above described a configuration of the device coordination service display apparatus according to this embodiment. Next, flow of processes performed by the device coordination service display apparatus according to this embodiment is described with reference to FIG. 5 and FIG. 6.

FIG. 5 is a flowchart showing an example of a GUI drawing processes performed by the device coordination service display apparatus according the embodiment of the present invention.

When the drawing processes performed by the device coordination service display apparatus starts, the GUI generating and drawing unit 105 obtains, in step S501 in FIG. 5, device coordination service information (see the data 300s in FIG. 3A) from the device coordination service information management unit 103.

The following describes, as an example for the sake of explanation, a case in which service information having the service ID “3001” and the service name “photo viewing service” is obtained from the device coordination service information table 300 in FIG. 3A managed by the device coordination service information management unit 103.

In the subsequent step S502, the GUI generating and drawing unit 105 which obtained the service information (the data 300s in the second row) having the service ID “3001” in FIG. 3A obtains device information (see the data 200s in FIG. 2) related to the service ID “3001” from the device information management unit 101.

At this time, the device information management unit 101 (i) extracts, from the device information table 200 in FIG. 2, based on the “coordination function” defined by the service ID “3001”, a device (information on the device) related to the service ID “3001” notified from the GUI generating and drawing unit 105 and (ii) notifies the GUI generating and drawing unit 105 of the extracted device.

Specifically, as the “coordination function” having the service ID “3001”, a service execution function, a photo data management function, and a photo data display function are indicated. Thus, the following processes of extraction from the device information table 200 in FIG. 2 are performed. In the extraction, the device ID “2003” (ninth row), a device ID “2001” (second row to fifth row), and a device ID “2002” (sixth row to eighth row) are extracted each of which is the device (the data 200s of the device) having as a “device function” (fourth column in FIG. 2) a function among the above-described functions. Then, each of the extracted pieces of the data 200s is notified to the GUI generating and drawing unit 105.

Subsequently, in step S503, the GUI generating and drawing unit 105 draws the GUI shown in FIG. 4 mentioned earlier, based on the obtained device coordination service information (the data 300s) and the device information (the data 200s).

Note that, the number of the devices drawn at a time is kept to the bare minimum in FIG. 4, and thus the “tablet” having the device ID “2003” is not displayed, as the node-type GUI component, as the device (the device on which a user directly performs operation) including a device coordination service display apparatus according to this embodiment. However, the node-type GUI component indicating the tablet may be displayed.

The above described with reference to FIG. 5 the flow of the GUI drawing processes performed by the device coordination service display apparatus according to the embodiment of the present invention.

FIG. 6 is a flowchart showing processes performed by the GUI control unit 108 when the GUI in FIG. 4 is operated by a user.

In FIG. 6, when the user operates, through an input device 107, the GUI displayed on the display device 106, the GUI control unit 108 identifies, in step S601, the GUI component on which the operation is performed.

Note that, here, as an example for the sake of explanation, it is assumed that the display device 106 is a touch panel display or the like including a touch panel that is the input device 107.

When the user performs an operation by touching the touch panel display, the input device 107 notifies to the GUI control unit 108 of coordinates (X, Y) on the touch panel where the user touched. The GUI control unit 108 identifies, from among the GUIs drawn by the GUI generating and drawing unit 105, the GUI component (the node-type GUI component or the button-type GUI component) which corresponds to the notified coordinates (X, Y). Note that, for the identification, information on drawing coordinates position and drawing range (width and height) of the GUI component is required as information for determining the correspondence, and such information shall be stored when the GUI generating and drawing unit 105 draws a GUI.

When the GUI component operated by the user is identified, the GUI control unit 108 executes, in step S602, the GUI behavior associated with the identified GUI component. For example, in FIG. 4, when a user selects and operates the button-type GUI component 404, the device coordination service indicated by the service URI (second row, fourth column) of the service ID “3001” (second row in FIG. 3A) can be executed as a GUI behavior associated with the button-type GUI component 404.

Specifically, the device coordination service designated by the service

URI of the service ID “3001” is defined by the executable-behavior definition file 301 in FIG. 3B. Thus, when selecting and operating the button-type GUI component 404, behavior of the function having, as a function attribute in the action tag of the executable-behavior definition file 301 in FIG. 3B, “showPhotoOnTV” is executed as the GUI behavior.

Note that, as for the association between the GUI behavior and the GUI components, an assigned relationship of association shall be stored when the GUI generating and drawing unit 105 draws the GUI.

Furthermore, the GUI behavior associated with the GUI component selected by a user is not limited to the execution behavior of the device coordination service. For example, an instruction may be provided to draw only information related to the selected GUI component or perform drawing in an emphasized manner (e.g., perform drawing with a different color, a bolder line, or a different type of line). In step S602, the GUI control unit 108 may perform a behavior for giving such an instruction to the GUI generating and drawing unit 105.

Note that, the user operation is not limited to the selection and operation of the node-type GUI component and the group node-type GUI component, but the user can also perform a drag-and-drop operation (see an operation 702m) onto the group node-type GUI component (see a group node-type GUI component 701 in FIG. 7A).

At this time, in step S601, the GUI control unit 108 may identify the dragged GUI component (a node-type GUI component 702) and a GUI component (the group node-type GUI component 701) onto which the dropping is performed. With this, the GUI control unit 108 can execute the GUI behavior assigned to the GUI component (the group node-type GUI component 701) onto which the dropping is performed.

Here, the GUI behavior assigned to the GUI component onto which the dropping is performed can be defined in advance. Note that, an example of the

GUI behavior of the group node-type GUI component 701 to be executed is, for example, an operation of adding, to the node-type GUI components included in the group of the group node-type GUI component 701, the node-type GUI component 702 which is dragged onto the group node-type GUI component 701.

For example, the function processing having, as a function attribute in the action tag of an executable-behavior definition file 302 in FIG. 3C, “addDevice” can be assigned as the GUI behavior of the case in which the dropping is performed. Furthermore, the GUI behavior of the case in which the node-type GUI component is dragged and dropped to outside the region of the group node-type GUI component can be assigned as a function processing having “removeDevice” as a function attribute in the action tag.

A specific example is described with reference to FIG. 7.

FIG. 7A is a diagram showing a GUI 7001.

FIG. 7B is a diagram showing a GUI 7002.

Each of FIG. 7A and FIG. 7B shows the state in which a power management service (see the service ID “3003” in the fourth row in FIG. 3A) indicated in the device information table 200 and devices having power control functions (see device IDs “2001”, “2002”, and “2004” in FIG. 2) are drawn by the GUI generating and drawing unit 105.

Note that, in the GUI 7001 in FIG. 7A, the node-type GUI component 702 indicating a “lighting in living room” is in a position which is not included in the group node-type GUI component 701 indicating a “power management service”. Thus, the “lighting in living room” is not subject to “turn power on collectively” and “turn power off collectively” that are performed with a user operation using the button-type GUI components (703 and 704).

The node-type GUI component 702 is dragged from the position which is not included, and dropped onto a position of the group node-type GUI component 701 (operation 702m) by a user. Then, the GUI control unit 108 executes the GUI behavior of the group node-type GUI component 701 onto which the dropping is performed, resulting in the state of GUI 7002 shown in FIG. 7B. With this, the “lighting in living room” becomes subject to the operations of “turn power on collectively” and the “turn power off collectively” in the “power management service”.

In other words, switching between ON and OFF of power includes a switching to a power OFF state with a button-type GUI component 703 and a switching to a power ON state with a button-type GUI component 704.

When the GUI 7002 in FIG. 7A is drawn, switching is performed on two devices, namely, a “TV in living room” and a “recording device in living room”. On the other hand, when the GUI 7002 in FIG. 7B is drawn after the above-described operation 702m is performed, switching is performed on three devices, namely, the two devices and the device “lighting in living room” that is the node-type GUI component 702 dragged in the operation 702m.

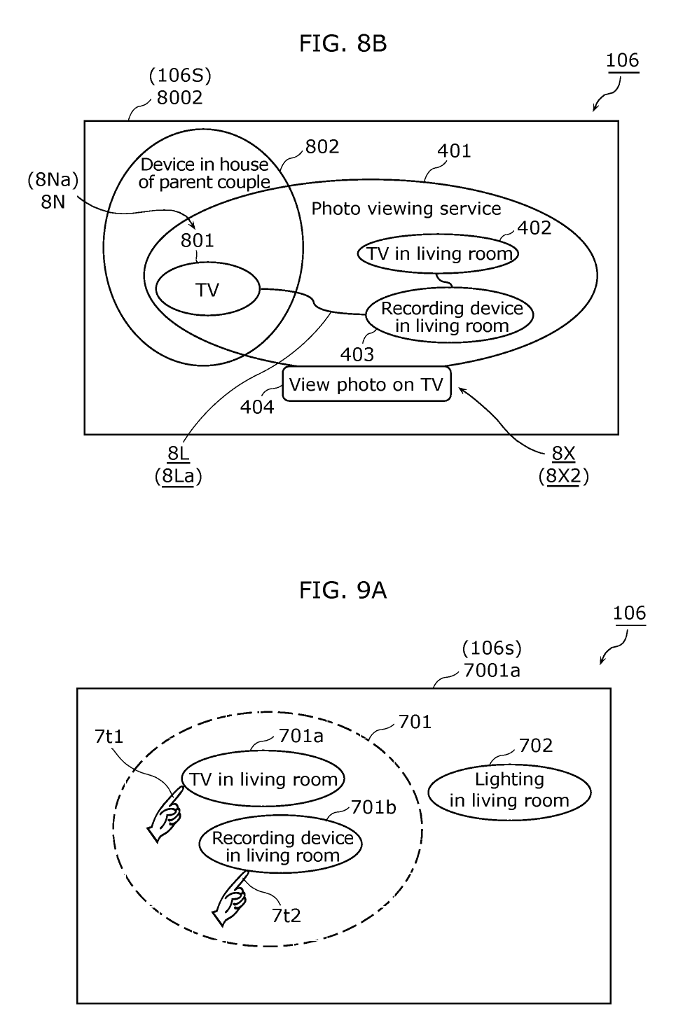

With the above-described drag and drop operation, the user operation shown in FIG. 8 is also possible.

FIG. 8A is a diagram showing a GUI 8001.

FIG. 8B is a diagram showing a GUI 8002.

In each of GUI 8001 in FIG. 8A and the GUI 8002 in FIG. 8B, a “photo viewing service” (the group node-type GUI component 401) is shown that is a service for displaying a photo to be viewed through a device (see device 1e2) such as a “TV in living room” which is provided in a house of the user (a first house 1H1 in FIG. 15) and is indicated by the node-type GUI component 702.

Furthermore, each of the GUIs shows a node-type GUI component 801 which is a “device in house of parent couple” and is a device (see device 1e (device 1e3) in the second house 1H2) connected to the information terminal 1t via the Internet (e.g., a network 1n in FIG. 15). The group node-type GUI component 401 and the node-type GUI component 801 are respectively drawn to be included in the group node-type GUI components (401 and 802).

Here, in the GUI 8001 in FIG. 8A, a user performs a drag and drop operation from a position where the group node-type GUI component 802 of the second house 1H2 including a “device in house of parent couple” (the node-type GUI component 801) is present. In the drag and drop operation, an item representing a TV (e.g., an icon) indicated by the node-type GUI component 801 is dragged to and dropped onto (see the operation 702m in FIG. 7A) a position of the “photo viewing service” (the group node-type GUI component 401) of the house of the user. Then, the displayed GUI 106S (see FIG. 8A and FIG. 8B (GUI 106s in FIG. 1)) becomes the GUI 8002 in FIG. 8B. This allows the TV (the device 1e3) in the house of the parent couple (the second house 1H2) to join the devices that are used in the photo viewing service. In other words, the one or more devices on which a photo is displayed include the TV provided in the house of the parent couple.

In other words, after joining, the user can display, on the “TV” (the device 1e3) in the house of the parent couple, a photo stored in the “recording device in living room” (see the device 1e1 (FIG. 15) in the first house 1H1, and the node-type GUI component 403) in the house of the user, just by operating the button-type GUI component 404 (“view photo on TV”).

In other words, for example, even through a user 1u2, who is a parent or the like of a child that is a user 1u1A in the first house 1H1, in the second house 1H2 is not used to an operation of a device 1e3, the following is achieved. Specifically, when the above-described process is simply executed with the information terminal 1t in the first house 1H1 of the user 1u1A who is the child, the same photo as the photo displayed in the first house 1H1 is also displayed on the device 1e3 in the second house 1H2. With this, an appropriate behavior for displaying a photo is performed in a number of houses. Thus, the appropriate behavior is achieved more reliably.

With the above-described configuration, the relationship between a plurality of devices which execute the device coordination service and the device coordination service can be represented with GUI, as a relationship diagram between the group node-type GUI component and the node-type GUI component.

Thus, the user who uses the device coordination service can confirm, with an easily comprehensible GUI representation, the relationship between the device coordination service and devices related to the device coordination service. Furthermore, with the operation of the button-type GUI component, the device coordination service can be easily executed.

Note that, the device and the device coordination service are described as examples of attribute values indicated by the group node-type GUI component and the node-type GUI component. On the other hand, as the attribute value shown in each of FIG. 8A and FIG. 8B is the “device in house of parent couple”, the indicated attribute value may be a “location” where a device is installed or a “person” who owns a device or a service.

For example, when the location is set to be the attribute value indicated by the group node-type GUI component, the user can define a location of a device with undefined location, simply by dragging and dropping such a device onto the group node-type GUI component.

Furthermore, when the attribute value indicated by the node-type GUI component is set to be a person who owns the device or the service, it is also possible to select and display only a device or a service owned by a “person” indicated by the node-type GUI component, by performing selection operation of the node-type GUI component.

Note that, as the attribute value, such as the “location” and the “person”, a predetermined attribute value may be defined in the device information table in FIG. 2 or the device coordination service information table in FIG. 3. The attribute value may also be dynamically added by a user operation.

Note that, in this embodiment, description is given on the premise that the device coordination service information managed by the device coordination service information management unit 103 and the device information managed by the device information management unit 101 are held in the device coordination service information table 104 and the device information table 102 in advance. On the other hand, the device coordination service information and the device information may be retrieved from a device connected to the network and dynamically added and managed.

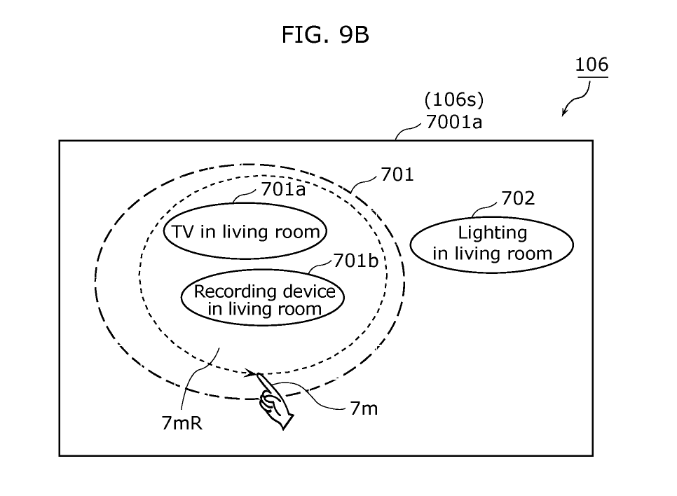

FIG. 9A is a diagram showing a GUI 7001a.

The drawn GUI may be, for example, the GUI 7001a shown in FIG. 9A.

The GUI 7001a includes two or more node-type GUI components (node-type GUI components 701a and 701b) which indicate devices (the “TV in living room” and the “recording device in living room”).

Touch operations (operations 7t1 and 7t2) may be performed on the two or more node-type GUI components.

After the touch operations are performed, the group node-type GUI component 701 may be drawn including the two or more node-type GUI components (the node-type GUI components 701a and 701b) on which the touch operations are performed.

Note that, for example, it may be that whether the devices indicated by the two or more node-type GUI components are two or more devices that behave in coordination is determined, and the group node-type GUI component 701 is drawn only when it is determined that the two or more devices behave in coordination, and the group node-type GUI component 701 is not drawn when it is determined that the two or more devices do not behave in coordination.

FIG. 9B is a diagram showing the GUI 7001a.

An operation 7m for identifying a region 7mR including the positions of the two or more node-type GUI components (the node-type GUI components 701a and 701b) may be performed.

After the operation 7m is performed, the group node-type GUI component 701 may be drawn which includes the two or more node-type GUI components that are positioned in the region 7mR specified by the operation 7m.

Note that, as shown in FIG. 9B, the operation 7m may be, for example, an operation in which the position of the finger of the user 1u1A is moved on the outer perimeter of the region 7mR.

Note that, the above-described group node-type GUI component 701 may be drawn only in the following case.

Specifically, there are combinations of devices that include the devices indicated by the two or more node-type GUI components (the node-type GUI components 701a and 701b) included in the group node-type GUI component 701. The above-described drawing may be performed only in the case where the combination is the combination that includes devices having functions identified by the third data 300c in a coordination information 300a (FIG. 3A).

FIG. 10 is a diagram showing a history information storage unit 109b and others.

The information terminal 1t may further include a history information storage unit 109b.

The history information storage unit 109b may store information 109n (data 109x including information 109n) which identifies a coordination behavior (e.g., a first coordination behavior in FIG. 10).

It may be assumed that a user (the user 1u1A in FIG. 15) to which the drawn GUI (see GUI 8x in FIG. 4) is presented has a higher probability to cause a certain coordination behavior to be executed than to cause another coordination behavior (e.g., a fourth coordination behavior in FIG. 10). The identified coordination behavior may be the above-described certain coordination behavior having a high probability.

In other words, the identified coordination behavior having the high probability is, for example, a coordination behavior which was executed by the user in the past.

It may be that the GUI 8x (FIG. 4) of the identified coordination behavior is drawn, and the GUI 8x of another coordination behavior is not drawn.

Note that, more specifically, an example of the information terminal 1t is a tablet as mentioned earlier.

More specifically, it is thinkable that the information terminal 1t be used by a plurality of the users 1u1 (FIG. 15) who is the members of a family of the first house 1H1 (FIG. 15) in which the information terminal 1t is used.

In other words, the information terminal 1t may be an information terminal other than for example a mobile phone used only by a single user.

A user identification unit 109a (FIG. 10) may identify, from among the users 1u1, the user 1u1A (FIG. 15) who is currently using the information terminal 1t to whom the drawn GUI 8x is presented.

The history information storage unit 109b may store data 109x for each of the users 1u1 (see a first and a second users in FIG. 10).

From among a plurality of pieces of data 109x, the data 109x of the identified user 1u1A may be identified by a selection unit 109c (FIG. 10).

Note that, as shown in FIG. 10, the selection unit 109c may be, for example, a part of the GUI generating and drawing unit 105 described earlier.

The identified data 109x may be used to draw only the GUI 8x for the coordination behavior identified by the data 109x as described above and to avoid drawing the GUI 8x for a different coordination behavior.

Note that, the FIG. 10 shows the GUI generating and drawing unit 105 in two positions. The two positions are, for example, one position which indicates a first part and another position which indicates a second part that are included in the GUI generating and drawing unit 105.

FIG. 11 includes a GUI 8xj, a GUI 8xk, and others.

The appearance of a button-type GUI component 703m included in the GUI 8xj is a first appearance, and the appearance of a button-type GUI component 703n included in the GUI 8xk is a second appearance different from the first appearance.

The first appearance is, for example, an appearance suitable for a button-type GUI component (the button-type GUI component 703m) which is operated relatively often.

In other words, the first appearance is, for example, an appearance including a relatively noticeable color (e.g., red, yellow, or the like that is more noticeable than black), an appearance including characters displayed in an emphasized manner, and an appearance in which characters are not translucent.

On the other hand, the second appearance is an appearance suitable for a button-type GUI component (the button-type GUI component 703n) which is operated for a relatively small number of times.

In other words, the second appearance is, for example, an appearance including a relatively less noticeable color (e.g., black), an appearance including characters displayed in an emphasized manner, or an appearance including characters which are translucent.

A GUI 8x for the coordination behavior indicated by the information 109n may be a GUI 8xj including the button-type GUI component 703m which is suitable for frequent operations.

On the other hand, a GUI 8x for a different coordination behavior may be a GUI 8xk including the button-type GUI component 703n which is suitable for less frequent operations.

FIG. 12 is a diagram showing a user information storage unit 109b and others.

Note that, with the information 109n, a device, such as a device (e.g., the first device) owned by a user (e.g., a first user in FIG. 12) corresponding to the information 109n, which is relatively frequently used by the user may be identified.

Note that, the relatively frequently used means that the number of times (the number of usages in a predetermined period) the device is used is greater than a threshold value, for example. The threshold value is the number of the times a different device (e.g., a fourth device) is used, for example.

In other words, with the information 109n, a coordination behavior achieved with the behaviors of the devices identified by the information 109n is indirectly identified. Thus, the coordination behavior may be indirectly identified (see FIG. 10).

The coordination behavior by the GUI 8xj that is described earlier may be, for example, the coordination behavior which is identified indirectly by the data 109x.

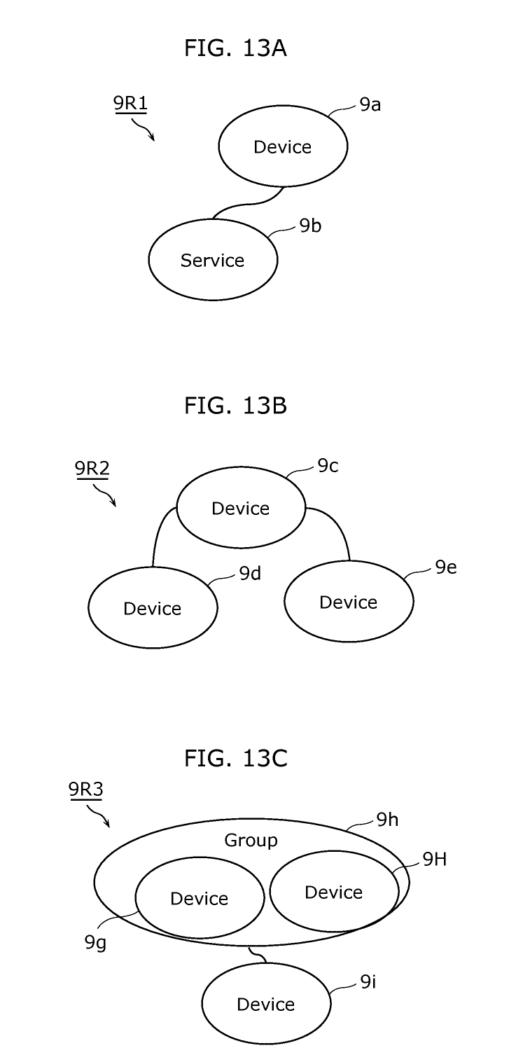

FIG. 13A is a diagram showing a GUI 9R1.

As shown, a GUI 9R1 including (i) a node-type GUI component 9a which indicates a device, (ii) a group node-type GUI component 9b which indicates a coordination behavior (a coordination service), and (iii) a line which connects the node-type GUI component 9a and the group node-type GUI component 9b may be drawn.

FIG. 13B is a diagram showing a GUI 9R2.

As shown, the GUI 9R2 including node-type GUI components 9c, 9d, and 9e each of which is a node-type GUI component indicating a device may be drawn.

In addition, as shown, the drawn GUI 9R2 may further include a line which connects the node-type GUI component 9c and the node-type GUI component 9d, and a line which connects the node-type GUI component 9c and the node-type GUI component 9e.

In other words, the drawn GUI 9R2 may represents a graph that is a tree in which the node-type GUI component 9c is a “root”, and each of the other two node-type GUI components 9d and 9e is a “leaf”.

FIG. 13C is a diagram showing a GUI 9R3.

Specifically, the GUI 9R3 including a group node-type GUI component 9h and a node-type GUI component 9i may be drawn.

The above-described group node-type GUI component 9h may include node-type GUI components 9g and 9H each of which is the node-type GUI component indicating a device.

As described, various GUIs (the GUIs 9R1, 9R2, and 9R3) may be drawn.

FIG. 14 is a diagram showing a first room 1H1a and a second room 1H1b of the house (the first house 1H1 in FIG. 15) including the information terminals 1t.

There may be a first region, such as a region including a first room 1H1a, and a second region, such as a region including a second room 1H1b.

Note that, for example, the first region may be a region including a main building, and the second region may be a region including a part other than the main building.

A device lea is a device 1e positioned in the first region (the region including the first room 1H1a).

A device 1eb is a device 1e positioned in the second region (the region including the second room 1H1b).

More specifically, for example, the information terminal 1t and the device 1e communicate wirelessly as described earlier.

When the information terminal 1t is positioned in the first region (see the information terminal 1ta in the first region), it may be that the information terminal 1t communicates with only a device lea positioned in the first region and does not communicate with a device 1eb positioned in the second region.

For example, when the information terminal 1t is positioned in the first region, it may be that the device information management unit 101 of the information terminal 1t obtains device information (data) 200s only from the device 1ea positioned in the first region and does not obtain the device information 200s from the device 1eb positioned in the second region.

Furthermore, when the information terminal 1t is positioned in the first region, the drawn GUI (screen) 106s (a GUI 106sa) may include only a node-type GUI component indicating a device lea positioned in the first region.

In other words, each of the devices that operates in coordination behavior of the group node-type GUI component included in the GUI 106s (GUI 106sa) may include only a device lea positioned in the first region.

FIG. 15 is a diagram showing the first house 1H1, the second house 1H2, and others.

The first house 1H1 is, for example, a house in which a child couple lives. In other words, in the first house 1H1, the user 1u1 is a young man or the like who can relatively easily operate the device 1e.

The second house 1H2 is, for example, a house in which a parent couple lives, and the user 1u2 in the second house 1H2 is an elderly person or the like who cannot relatively easily operate the device 1e.

The above-described processes performed through the information terminal 1t may be performed in the system 1s.

Specifically, in the coordination behavior, the first device 1e1 that is a recording device or the like in the first house 1H1 may read an image, such as a photo or a video, recorded in a recoding medium included in the first device 1e1.

Furthermore, the second device 1e2, which is a TV or the like, positioned in the first house 1H1 may obtain and display the read image.

Furthermore, at the same time when the image is displayed in the first house 1H1, the image the same as the image shown in the first house 1H1 may be displayed on the third device 1e3 positioned in the second house 1H2.

Note that, such a simultaneous displaying may be started after, for example, the user 1u1A or the like who is the user 1u1 in the first house 1H1 informing the user 1u2 in the second house 1H2 by a phone or the like that the simultaneous displaying will be started soon.

When the coordination behavior by the first to the third devices 1e1 to 1e3 is executed, the processes performed through the information terminal 1t may be the processes described earlier.

Note that, the third device 1e3 may be, among a plurality of devices 1eA positioned in the second house 1H2, the device 1e or the like having a predetermined function, determined by the GUI generating and drawing unit 105 or the like.

For example, the identified device 1e is a device having, as a function of the device 1e identified by the device information 200s obtained from the device 1e, the above-described predetermined function.

Note that, the obtainment of the device information 200s from the second house 1H2 may be performed, for example, via a network in, such as the Internet.

Note that, the above-described predetermined function is, for example, a function included in the functions (see third data 300c in FIG. 3A) that are identified by the obtained coordination information 300s.

Note that, a first storage unit 102s (see FIG. 1) which stores device information 200s (the device information table 102) may be provided.

The first storage unit 102s may be, as shown in FIG. 1, a part of the information terminal 1t or external to the information terminal 1t.

The device information 200s obtained by the device information management unit 101 may be the device information 200s which is stored in and obtained from the first storage unit 102s.

Note that, the first storage unit 102s which is a part of the information terminal 1t may store the device information 200s that is obtained by the device information management unit 101 from outside the information terminal 1t.

Note that, in a similar manner, a second storage unit 104s which stores the coordination information 300s may be provided.

Furthermore, the second storage unit 104s may be, as with the above-described first storage unit 102s, a part of the information terminal 1t or may be external to the information terminal 1t.

The coordination information 300s obtained by the device coordination service information management unit 103 may be the coordination information 300s stored in the second storage unit 104s.

Note that, the DLNA technique described earlier may be used to obtain the device information.

FIG. 16 is a diagram showing a GUI 1600.

In FIG. 16, the GUI generating and drawing unit 105 draws two or more node-type GUIs (node-type GUI components 1601 and 1602) which indicate two or more devices connected to a network. Furthermore, the GUI generating and drawing unit 105 also draws a line (a line 1604) that is a straight line or a curved line which connects the two or more node-type GUI components.

Furthermore, in addition to the two or more node-type GUI components and the line, the GUI generating and drawing unit 105 draws, on the above-described line, a node-type GUI component (a node-type GUI component 1603) indicating a coordination service (coordination behavior) achieved by the above-described two or more devices.

Note that, in addition to the above-described line, the GUI generating and drawing unit 105 may draw a symbol (a symbol 1604a) which indicates the direction of data flow or control flow among the above-described two or more devices in the coordination service.

Note that, when the line is drawn, the above-described symbol (the symbol 1604a) may be drawn as a part of the line. The line may be, for example, an arrow including the above-described symbol.

This produces the following advantageous effects. In other words, there is a relationship between (i) the two or more devices (see the node-type GUI components 1601 and 1602) which behave in coordination and (ii) a function (see the node-type GUI component 1603) that is achieved by the coordination behavior executed by the two or more functions of the two or more devices. This relationship can be presented to a user in a relatively easily comprehensible manner. Furthermore, a symbol indicating the direction of action that is a direction in which action, such as a data communication, is made which occurs when a coordination behavior is performed by the two or more devices. Note that, the action is, for example, an action of dataflow or a control flow. With this drawing, the coordination behavior between the above-described two or more devices can be presented to a user in a more easily comprehensible manner. Thus, the presentation is provided in a more appropriate manner.

Note that, the position at which the node-type GUI component 1603 is drawn is, for example, a position in a range near the line 1604.

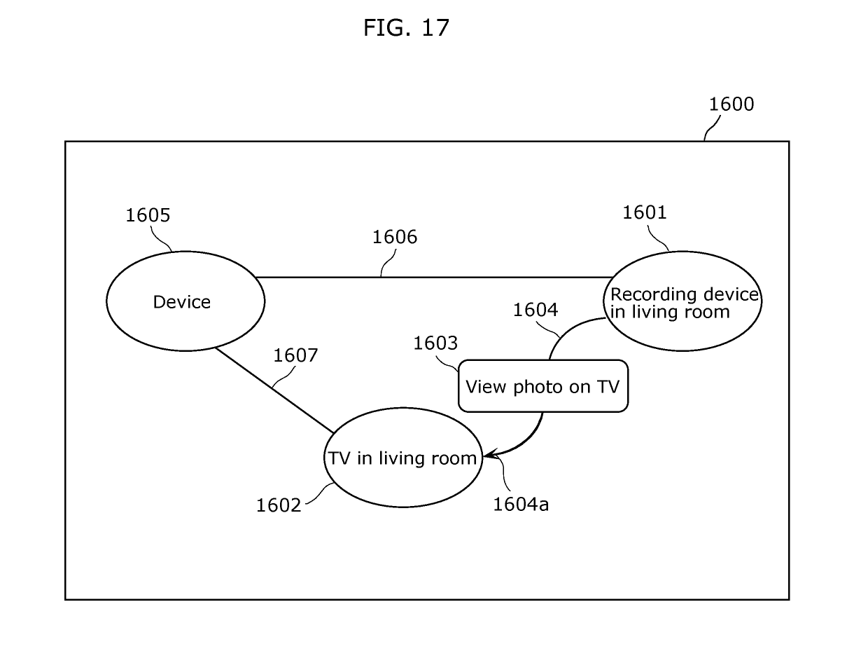

FIG. 17 shows the GUI 1600 of a case including three or more devices.

FIG. 17 also shows a node-type GUI component 1605 indicating a device. Note that, the device is, for example, a digital camera. Furthermore, FIG. 17 also shows a line 1606 which connects the node-type GUI component 1605 and the node-type GUI component 1601, and a line 1607 which connects the node-type GUI component 1605 and the node-type GUI component 1602.

As the example of FIG. 17 shows, the device may include three or more devices (see the node-type GUI components 1601, 1602, and 1605). The three or more devices include two or more devices (see two node-type GUI components 1601 and 1602) which perform a coordination behavior (in the example of FIG. 17, a coordination behavior of a service “view photo on TV”). In the example of FIG. 17, the two or more devices are a recording device in a living room and a TV in a living room.

Furthermore, at the position of the node-type GUI component 1603 indicating coordination information (“view photo on TV”), the line 1604 exists. The node-type GUI component 1603 may show, as the two or more devices which perform the coordination behavior, the two or more devices (the recording device and the TV) indicated by the two or more node-type GUI components (the node-type GUI components 1601 and 1602) that are connected by the line 1604 positioned as described above.

In other words, there are two or more devices (e.g., two devices indicated by the two node-type GUI components 1601 and 1605 connected by the line 1606) connected by lines (the lines 1606 and 1607) other than the line 1606. The two or more devices may be identified as two or more devices which do not perform the coordination behavior (“view photo on TV”).

With this, even when three or more devices are provided, the two or more devices which perform the coordination behavior are displayed in a suitable, easily comprehensive manner. Thus, a suitable representation is ensured.

Note that, the node-type GUI component 1603 may be positioned at a position relatively near the positions of the two or more node-type GUI components (the node-type GUI components 1601 and 1602) which indicate the above-described two or more devices which perform the coordination behavior. Furthermore, the node-type GUI component 1603 may be positioned at a position relatively far from the position of the node-type GUI component (e.g., the node-type GUI component 1605) which indicates a device other than the two or more devices that perform the coordination behavior. In this manner, the two or more devices indicated by the two or more node-type GUI components (the two node-type GUI components 1601 and 1602) which are relatively closely positioned may be indicated as the two or more devices which perform the coordination behavior. Furthermore, a device indicated by the node-type GUI component (the node-type GUI component 1605) positioned relatively far from the position of the node-type GUI component 1603 may be indicated as another device.

The node-type GUI component 1603 may be thus associated with the line 1604.

Note that, as stated in the description of the above-described symbol 1604a, the coordination behavior may include a flow, such as a flow of communication. The coordination behavior may be achieved by the performance of the behavior according to the flow, such as the communication according to the flow.

Note that, for example, the information terminal 1 is a terminal, such as a portable tablet terminal or a smartphone.

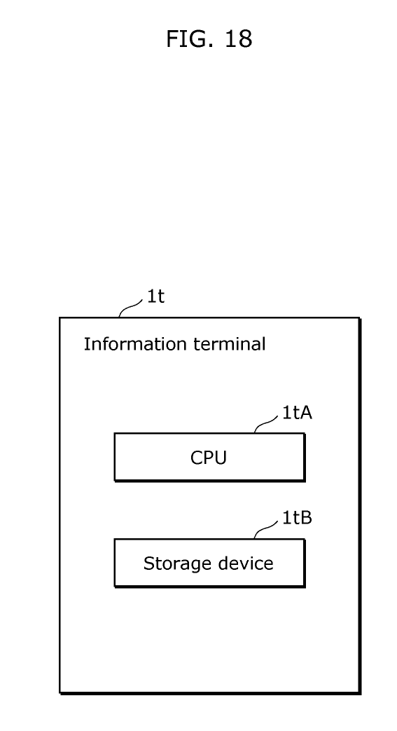

FIG. 18 is a diagram of the information terminal 1t.

For example, the information terminal 1t may include a CPU 1tA, and a storage device 1tB, such as a RAM, a ROM, or a HDD, which stores a program.

The storage device 1tB may store a program for realizing a part or the like of the above-described functions of the information terminal 1t. The stored program may be executed by the CPU 1tA, and the above-described part or the like of the function may be thus realized with the information terminal 1t.

For example, the above-described part or the like of the function may include a function of the device coordination service information management unit 103 shown in FIG. 1. Furthermore, the function of the device information management unit 101 may be included. Furthermore, the function of the GUI generating and drawing unit 105 may be included.

Note that, for example, the above-described part or the like of the function may include a function of the GUI control unit 108 and other functions.

On the other hand, the input device 107 in FIG. 1 may be, for example, a sensor which receives a touch operation or the like performed by a user on the touch panel or the like included in the information terminal 1t and obtains an input of the operation.

Furthermore, for example, the display device 106 in FIG. 1 may be a display unit or the like which is a part of the above-described touch panel or the like and displays a GUI, such as the GUI 1600 in FIG. 17 described earlier.

Note that, the device coordination service information table 104 in FIG. 1 may be information stored in a storage device, such as the above-described storage device 1tB shown in FIG. 18. Furthermore, likewise, the device information table 102 may be information stored in the storage device.

Note that, the information terminal 1t in FIG. 1 is an example of a “GUI generator” in CLAIMS. Likewise, the device information management unit 101, the device coordination service information management unit 103, the GUI generating and drawing unit 105, the display device 106, the input device 107, and the GUI control unit 108 are respectively examples of a “device information obtainment unit”, a “coordination information obtainment unit”, a “GUI drawing unit”, a “display device”, an “input device”, and a “GUI control unit” in CLAIMS.

Note that, in this manner, for example, the data which identifies a GUI in which a GUI component is drawn may be generated and the GUI identified by the data may be displayed.

Note that, each of the procedure performed by the device coordination service display apparatus according to the embodiment of the present invention described above may be implemented by a CPU interpreting and executing predetermined program data that allows the execution of the above described procedures stored in a memory apparatus (a ROM, a RAM, a hard disk, and so on). In this case, the program data may be installed onto the memory apparatus through a storage medium, or may be directly executed from a storage medium. It is to be noted that the storage medium is, for example, a semiconductor memory, such as a ROM, a RAM, and a flash memory; a magnetic disk memory, such as a flexible disk and a hard disk; an optical disk memory, such as a CD-ROM, a DVD, and a BD; and a memory card. In addition, the recording medium is a concept including a communication medium, such as a phone line and a carrier route.

Furthermore, each of the structural components included in a drawing performance profile display device according to the embodiment of the present invention described above may be implemented as a large-scale integration (LSI) which is an integrated circuit. The structural components may be integrated into separate single chips, or some or all of the structural components may be integrated into a single chip. The name used here is LSI, but it may also be called IC, system LSI, super LSI, or ultra LSI depending on the degree of integration.

Furthermore, the method of circuit integration is not limited to LSIs, and implementation through a dedicated circuit or a general-purpose processor is also possible. A field programmable gate array (FPGA) that allows programming after LSI manufacturing or a reconfigurable processor that allows reconfiguration of the connections and settings of the circuit cells inside the LSI may also be used. In addition, depending on the emergence of circuit integration technology that replaces LSI due to progress in semiconductor technology or other derivative technology, it is obvious that such technology may be used to integrate the function blocks. Possibilities in this regard include the application of biotechnology and the like.

Note that the following program may be used.

The program is a graphical user interface (GUI) generating program or the like for causing a computer to execute each of the above-described steps in the GUI generating method, including: obtaining device information identifying a first device and a second device which are connected to a network; obtaining coordination information which identifies a coordination behavior achieved with a first function of the first device and a second function of the second device; and drawing first and second GUI components and a third GUI component in association with each other, the first and the second GUI components indicating the first and the second devices identified by the device information, and the third GUI component indicating the coordination behavior identified by the coordination information.

### INDUSTRIAL APPLICABILITY

A device coordination service display apparatus according to the present invention can draw the device coordination service, which includes a plurality of devices that operate in coordination, as a relationship between the node-type GUI components, and present the drawing to the user, and thus can present, in an easily comprehensible manner, the relationship between the device coordination service and the devices which is not clear to the user. Thus, the GUI according to the technique described here is useful as a GUI which makes it possible for the user to use the device coordination service easily.

### REFERENCE SIGNS LIST

1t Information terminal

101 Device information management unit

102 Device information table

103 Device coordination service information management unit

104 Device coordination service information table

105 GUI generating and drawing unit

106 Display device

107 Input device

108 GUI control unit

200 Device information table

300 Device coordination service information table

301 Executable-behavior definition file

302 Executable-behavior definition file

401 Group node-type GUI component

402 Node-type GUI component

403 Node-type GUI component

404 Button-type GUI component

701 Group node-type GUI component

702 Node-type GUI component

703 Button-type GUI component

704 Button-type GUI component

801 Node-type GUI component

802 Group node-type GUI component

1600, 7001, 7002, 8001, 8002 GUI

1601, 1602, 1603, 1605 Node-type GUI component

1604, 1606, 1607 Line

1604a Symbol

1. A graphical user interface (GUI) generator, comprising:
a device information obtainment unit configured to obtain device information identifying a first device and a second device which are connected to a network;
a coordination information obtainment unit configured to obtain coordination information which identifies a coordination behavior achieved with a first function of the first device and a second function of the second device; and
a GUI drawing unit configured to draw first and second GUI components and a third GUI component in association with each other, the first and the second GUI components indicating the first and the second devices identified by the device information, and the third GUI component indicating the coordination behavior identified by the coordination information.

2. The GUI generator according to claim 1,
wherein the coordination information identifies the first and the second functions for achieving the coordination behavior, and
the first device is a device indicated by the device information as having the identified first function, and the second device is a device indicated by the device information as having the identified second function.

3. The GUI generator according to claim 1, further comprising:
a display device which displays a GUI including the first to the third GUI components drawn by the GUI drawing unit;
an input device which receives an operation performed by a user on a GUI component included in the GUI; and
a GUI control unit configured to execute a GUI behavior associated with the GUI component selected by the user with the operation received by the input device.

4. The GUI generator according to claim 1,
wherein the GUI drawing unit is configured to draw a line which connects the first GUI component and the second GUI component, the line being a straight line or a curved line.

5. The GUI generator according to claim 3,
wherein the GUI drawing unit is configured to (i) draw information representing the GUI component on which the operation received by the input device is performed, and, (ii) after the receipt, draw the information in a manner different from a manner in which the information is drawn before the receipt.

6. The GUI generator according to claim 1
wherein the GUI drawing unit is configured to (i) draw the first and the second GUI components indicating the first and the second devices and (ii) draw, as the third GUI component indicating the coordination behavior, a group node-type GUI component indicating a group which includes the first and the second GUI components.

7. The GUI generator according to claim 3,
wherein in a case where the input device receives a drag-and-drop operation of a fourth GUI component indicating one device to the drawn third GUI component performed by a user, the GUI control unit is configured to register the one device indicated by the fourth GUI component, as one of devices that operate when the coordination behavior is executed which is indicated by the third component on which the drag-and-drop operation is performed.

8. The GUI generator according to claim 1, further comprising
a history storage unit configured to store data which identifies a total number of executions of the coordination behavior,
wherein the GUI drawing unit is configured to (i) perform a drawing in a form suitable for a case in which a total number of operations is relatively large, when the total number of executions identified by the stored data is larger than a threshold value, and (ii) perform a drawing in a form suitable for a case in which the total number of operations is relatively small, when the total number of executions identified by the stored data is smaller than the threshold value.

9. The GUI generator according to claim 1, further comprising
a storage unit configured to store data which identifies a device owned by a user of the GUI generator,
wherein the GUI drawing unit is configured to (i) perform a drawing in a form suitable for a case in which a total number of operations is relatively large, in a case where a function of the owned device identified by the data is used when the coordination behavior is executed, and (ii) perform a drawing in a form suitable for a case in which the total number of operations is relatively small, in a case where the function of the owned device identified by the data is not used when the coordination behavior is executed.

10. The GUI generator according to claim 9,
wherein the storage unit is configured to store a plurality of pieces of the data,
each of the pieces of the data identifies a device owned by, among a plurality of the users, the user corresponding to the piece of the data,
the GUI generator further comprises an identification unit configured to identify, among the users, a user to which the GUI is presented, and
the GUI drawing unit is configured to perform a drawing in one of (i) a form suitable for the case in which the total number of operations is relatively large and (ii) a form suitable for the case in which the total number of operations is relatively small, according to the data of the identified user.

11. The GUI generator according to claim 1,
wherein the device information obtainment unit is configured to communicate wirelessly with two or more devices including the first and the second devices positioned in a neighboring area of the GUI generator,
the device information identifies the two or more devices positioned in the neighboring area, and avoids identifying a device positioned in an area different from the neighboring area, and
the GUI drawing unit is configured to (i) draw only two or more GUI components indicating the two or more devices positioned in the neighboring area, and (ii) avoid drawing a GUI component of the device positioned in the area different from the neighboring area.

12. The GUI generator according to claim 3,
wherein a system including the GUI generator includes the first and the second devices, and a third device,
the first and the second devices are provided in a first house,
the third device is provided in a second house,
the coordination behavior is achieved with (i) the first and the second functions of the first and the second devices in the first house and (ii) a third function of the third device in the second house, the third function being a function same as the second function,
the GUI drawing unit is further configured to draw a GUI component indicating the third device, and
the GUI control unit is configured to cause, as the GUI behavior that is executed when the operation is received, (i) the first and the second devices to behave with the first and the second functions, respectively, and (ii) the third device to behave with the third function.

13. The GUI generator according to claim 1,
wherein in a case where the GUI generator includes the second function, the GUI generator performs, as the second device, a behavior with the second function when the coordination behavior is executed.

14. The GUI generator according to claim 4,
wherein the third GUI component is associated with the line which connects the first GUI component and the second GUI component.

15. The GUI generator according to claim 14,
wherein the third GUI component is drawn on the line.

16. The GUI generator according to claim 3,
wherein the line is an arrow indicating a direction of flow of data between the first device indicated by the first GUI component and the second device indicated by the second GUI component when the coordination behavior is executed.

17. The GUI generator according to claim 1,
wherein the third GUI component is drawn between the first GUI component and the second GUI component.

18. An integrated circuit, comprising:
a device information obtainment unit configured to obtain device information identifying a first device and a second device which are connected to a network;
a coordination information obtainment unit configured to obtain coordination information which identifies a coordination behavior achieved with a first function of the first device and a second function of the second device; and
a graphical user interface (GUI) drawing unit configured to draw first and second GUI components and a third GUI component in association with each other, the first and the second GUI components indicating the first and the second devices identified by the device information, and the third GUI component indicating the coordination behavior identified by the coordination information.

19. A graphical user interface (GUI) generating method, comprising:
obtaining device information identifying a first device and a second device which are connected to a network;
obtaining coordination information which identifies a coordination behavior achieved with a first function of the first device and a second function of the second device; and
drawing first and second GUI components and a third GUI component in association with each other, the first and the second GUI components indicating the first and the second devices identified by the device information, and the third GUI component indicating the coordination behavior identified by the coordination information.

20. A non-transitory computer-readable recording medium having a graphical user interface (GUI) generating program recorded thereon for causing a computer to execute:
obtaining device information identifying a first device and a second device which are connected to a network;
obtaining coordination information which identifies a coordination behavior achieved with a first function of the first device and a second function of the second device; and
drawing first and second GUI components and a third GUI component in association with each other, the first and the second GUI components indicating the first and the second devices identified by the device information, and the third GUI component indicating the coordination behavior identified by the coordination information.
